(19) United States
(12) Patent Application Publication
(10) Pub. No.: US 2014/0305779 A1
(43) Pub. Date: Oct. 16, 2014

(54) CIRCUIT BREAKER INDICATION DEVICE

(71) Applicant: Joseph Mezzo, Manalapan, NJ (US)

(72) Inventor: Joseph Mezzo, Manalapan, NJ (US)

(21) Appl. No.: 13/934,930

(22) Filed: Jul. 3, 2013

Related U.S. Application Data
(60) Provisional application No. 61/810,937, filed on Apr. 11, 2013.

(51) Int. Cl. H01H 9/16

(52) U.S. Cl. CPC H01H 9/161
USPC 200/310

(57) ABSTRACT

A circuit breaker device with an integrated indication light display. The integrated indication light display may display a representation of the amount of current running through a circuit that the circuit breaker device is connected to. The indication light display may be a Light Emitting Diode Bar and may display multi levels indicating whether there will be a circuit overload.

### CROSS-REFERENCE TO RELATED APPLICATION

This application claims the benefit of priority of U.S. provisional application No. 61/810,937, filed Apr. 4, 2013, the contents of which are herein incorporated by reference.

### BACKGROUND OF THE INVENTION

The present invention relates to a circuit breaker indication device and, more particularly, to a circuit breaker indication device integrated with the circuit breaker.

A circuit breaker is an automatically operated electrical switch designed to protect an electrical circuit from damage caused by overload or short circuit. Its basic function is to detect a fault condition and interrupt current flow. Unlike a fuse, which operates once and then must be replaced, a circuit breaker can be reset (either manually or automatically) to resume normal operation. Circuit breakers are made in varying sizes, from small devices that protect an individual household appliance up to large switch gear designed to protect high-voltage circuits feeding an entire city.

Currently, electrical circuit breakers may be over utilized, may be ready to trigger off, or may be underutilized. There is no indicator on the breaker showing early warnings of an overload. Other displays on the market are separate from the actual circuit breaker. Therefore, to determine early signs of an overload, invasive circuit breaker panel work may be required, which may be time consuming and difficult to perform.

As can be seen, there is a need for an integrated device that provides warnings for overloaded circuit breakers.

### SUMMARY OF THE INVENTION

In one aspect of the present invention, a circuit breaker comprises: a housing containing the circuit breaker; an indication light display integrated into the circuit breaker, wherein the indication light display is displayed on an outside surface of the housing; a current transformer operatively connected to a monitored circuit and the indication light display, wherein the current transformer detects a current running through the monitored circuit and displays a representation of the current on the indication light display.

In another aspect of the present invention, a method of displaying an amount of current running through a circuit comprises: providing a circuit breaker comprising: a housing containing the circuit breaker; an indication light display integrated into the circuit breaker, wherein the indication light display is displayed on an outside surface of the housing; a current transformer operatively connected to a monitored circuit and the indication light display; determining an amount of amps running through the monitored circuit using the current transformer; and displaying a representation of the amount of amps on the indication light display.

These and other features, aspects and advantages of the present invention will become better understood with reference to the following drawings, description and claims.

### BRIEF DESCRIPTION OF THE DRAWINGS

FIG. 1 is a perspective view of the present invention shown in non-overload condition;

FIG. 2 is a perspective view of the present invention shown in overload condition; and

FIG. 3 is a schematic-electrical view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a circuit breaker device with an integrated indication light display. The integrated indication light display may display a representation of the amount of current running through a circuit that the circuit breaker device is connected to. The indication light display may be a Light Emitting Diode Bar and may display multi levels indicating whether there will be a circuit overload.

The present invention may include a device that determines and displays a current level from a circuit breaker. The induction created by the wire feeding circuit breaker may drive an indicating device, such as a display. The present invention may provide a visual display of up to all of the circuits in a panel. Therefore, the present invention may provide an early warning of any circuit that is close to overloading and thereby provides a warning for a potential electrical fire. Further, in certain embodiments, the device may display which circuits are underutilized. The indicating display of the present invention may be integrated with the circuit breaker and may easily be installed into a circuit breaker panel.

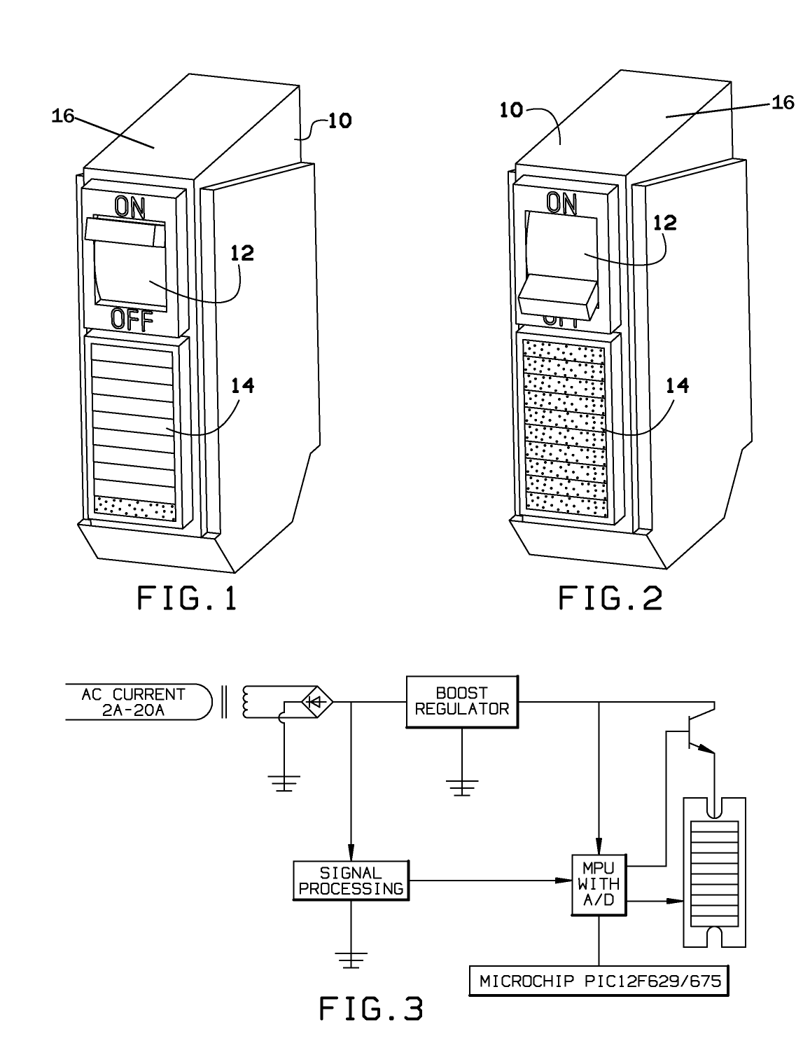

Referring to FIG. 1 through 3, the present invention may include a circuit breaker housing 16 containing a standard circuit breaker 10. The circuit breaker 10 may further include an indication light display 14. In certain embodiments, the indication light display 14 may include a series of lights that may move up and down a bar. In certain embodiments, the series of lights may be a Light Emitting Diode (LED) bar. For example the LED bar may be a Kingsbright® LED display. However, it is envisioned that the indication light display 14 may be any display including, but not limited to, Liquid Crystal Display, Organic LED, plasma, or any suitable displaying device. As illustrated in FIGS. 1 and 2, the indication light display 14 may display a non-overload condition, only displaying one lit bar and up to an overload condition, in which all bars may be lit.

In certain embodiments, the circuit breaker 10 of the present invention may be powered by a current transformer. The current transformer may be used to measure alternating electric currents. When the current is too high to measure, the current transformer may produce a reduced current that is accurately proportional to the current in the circuit so that the current may be measured. In certain embodiments, the current transformer may be a Triad® CT. The current transformer may sense the alternating current and supply a signal to an integrated circuit or a multi processor unit.

As illustrated in FIG. 3, the integrated circuit may receive and process the signal in the signal processing box. The boost regulator may stabilize the voltage that is read through the current transformer. The integrated circuit may sense analog voltage levels and drive the indication light display 14. The integrated circuit may control the cascading indication light display by feeding the analog signal and proportionally lighting up the lights, such as LED segments, on the indication light display 14. In certain embodiments, the integrated circuit may be protected by resistors, such as two resistors. The integrated circuit of the present invention may include an LM 3916.

In certain embodiments, a multi processor unit (MPU) containing a microchip may be used. The MPU may receive the information from the current transformer and then display a representative level of current on the indication light display 14, such as the LED bar mentioned above. The more AC current that is used, the more segments on the LED bar are displayed. For example, if fifteen amps are going through the current transformer, all the LED bars may be lit, including red LED bars indicating a maximum capacity of the circuits. Conversely, if only one amp is going through the current transformer, only a single green LED bar may be lit.

In alternative embodiments, the present invention may further include a software application on a smart device. Instead of, or in addition to the indication light display 14, the circuit breaker 10 may further include a wireless transmitting component, such as Wi-Fi. The wireless transmitting component may transmit a level of current running through the circuit to the software application. The software application may then display a representation of the amount of current on the smart device. Therefore, a user may use a smart device to determine whether a circuit is about to be overloaded, functioning normally, or whether the circuit is being underutilized.

It should be understood, of course, that the foregoing relates to exemplary embodiments of the invention and that modifications may be made without departing from the spirit and scope of the invention as set forth in the following claims.

1. A circuit breaker comprising:
a housing containing the circuit breaker;
an indication light display integrated into the circuit breaker, wherein the indication light display is displayed on an outside surface of the housing; and
a current transformer operatively connected to a monitored circuit and the indication light display,
wherein the current transformer detects a current running through the monitored circuit and displays a representation of the current on the indication light display.

2. The circuit breaker of claim 1, further comprising an integrated circuit, wherein the integrated circuit receives and processes a current measurement sent from the current transformer and displays a representation of the current on the indication light display.

3. The circuit breaker of claim 1, further comprising a multi processor unit, wherein the multi processor unit receives and processes a current measurement sent from the current transformer and displays a representation of the current on the indication light display.

4. The circuit breaker of claim 1, wherein the indication light display comprises a bar comprising a plurality of Light Emitting Diodes.

5. The circuit breaker of claim 1, further comprising an on and off switch operatively connected to the circuit breaker.

6-10. (canceled)

11. A circuit breaker comprising:
a housing containing the circuit breaker;
an on and off switch operatively connected to the circuit breaker;
an indication light display integrated into the circuit breaker, wherein the indication light display is displayed on an outside surface of the housing; and
a current transformer operatively connected to a monitored circuit and the indication light display; and
an integrated circuit that receives and processes a current measurement sent from the current transformer and displays a representation of the current on the indication light display.

12. The circuit breaker of claim 11, wherein the indication light display comprises a bar comprising a plurality of Light Emitting Diodes.

13. A circuit breaker comprising:
a housing containing the circuit breaker;
an on and off switch operatively connected to the circuit breaker;
an indication light display integrated into the circuit breaker, wherein the indication light display is displayed on an outside surface of the housing; and
a current transformer operatively connected to a monitored circuit and the indication light display; and
a multi processor unit that receives and processes a current measurement sent from the current transformer and displays a representation of the current on the indication light display.

14. The circuit breaker of claim 13, wherein the indication light display comprises a bar comprising a plurality of Light Emitting Diodes.
